(19) United States
(12) Patent Application Publication
(10) Pub. No.: US 2025/0179828 A1
(43) Pub. Date: Jun. 5, 2025

(54) Monopole Tower Assembly

(71) Applicant: Amplitel Pty Ltd, Melbourne (AU)

(72) Inventor: Andreea LUCA, Ryde (AU)

(73) Assignee: Amplitel Pty Ltd, Melbourne (AU)

(21) Appl. No.: 18/840,219

(22) PCT Filed: Feb. 21, 2023
(86) PCT No.: PCT/AU2023/050119

§ 371 Date: Aug. 21, 2024

(30) Foreign Application Priority Data
Feb. 23, 2022 (AU) 2022900419

(51) Int. Cl. E04H 12/24

(52) U.S. Cl. CPC E04H 12/24

(57) ABSTRACT

A reinforcement assembly for a monopole that comprises three or more columns that are secured in spaced relation away from an outer surface of the monopole. Each of the columns has a cross-section that defines a square or rectangular hollow section and is arranged to extend between a first and second distal end, where the first distal end of each of the columns is secured to a foundation of the monopole, and the second distal end of each of the columns is located at a height that above a height of the first distal end. The columns are arranged such that, in use, a load applied to the monopole is distributed between the monopole and each of the three or more columns.

### TECHNICAL FIELD

This disclosure relates generally to monopole towers, and in particular to an assembly and method for strengthening existing monopole towers.

### BACKGROUND

Monopole towers are used to support a wide range of antenna headframes and mounts for a variety of communication applications such as for cellular or wireless internet networks. As communication networks are upgraded and capacity increased, additional antennas and headframes need to be added or installed.

In some locations, additional monopole towers can be installed to support the additional antenna headframes, however installation of additional monopole towers is not always permitted, cost effective or feasible. In such instances, the additional headframe/s is/are fitted onto the existing tall, slender monopole towers already in situ. Monopole towers can be relatively thin and long tubular structures, having a larger base diameter that tapers down to a thinner diameter as it approaches the upper end of the monopole tower.

Monopole towers are often installed in isolation, or with the antennas exposed above any adjacent buildings where they can receive and transmit signals without interference. This may result in an exposure of the upper portion of the monopole tower to strong winds or other weather conditions that apply lateral or bending moment forces to the monopole tower in addition to the weight force of the electronic equipment, and other equipment fixed to the tower. Moment forces can cause the tower to sway and/or have a pronounced bend or lean, or in some extreme circumstances to fail and collapse. Thus, the structural strength of an individual monopole tower must be considered when assessing suitability for retrofitting additional headframes or other electronic equipment onto the monopole. The number of antenna headframes each monopole tower can hold is correlated with its structural features and integrity.

The costs associated with replacing an existing monopole tower, including the costs of the network downtime, the materials costs, and the costs of installation, render the option of removing an existing monopole tower to build a stronger monopole tower generally unattractive as a solution.

For this reason, a variety of techniques have been developed for strengthening existing monopole towers.

One such solution is disclosed in Australian Patent Application 2012201882, where a second large concrete foundation is set around the base of the monopole and a stiff hollow strengthening tower is constructed around the monopole in stages, with the first stage being placed on the second large concrete foundation. Each stage comprises of two ‘half-pipe’ sections which are semicircular in horizontal section that are placed around the monopole using a crane. The top stage carries four clamps that grip the outside of monopole forming a ‘pinned’ connection that provides ‘roller’ support and changes the existing cantilever structure of the monopole into a ‘propped’ cantilever structure, thereby enabling the majority of any force caused by bending in the monopole to be transferred through the ‘pinned’ connection to the hollow strengthening tower.

However, this solution has a number of shortcomings. For example, installation of the hollow strengthening tower requires space for the extended foundation, and that space is not always available. The gap provided between the monopole and the hollow strengthening tower is relatively narrow, making it difficult for an operator to service the monopole. For example, to assess corrosion of the monopole tower behind the hollow strengthening tower, to service existing cable trays, or to run additional cable trays up the monopole tower when it is necessary to add additional headframes. In addition, construction and installation requires a significant amount of time and effort, and may in some instances also require the removal of one or more existing headframes to accommodate for the installation of the new hollow strengthening tower.

There is a need for at least a useful alternative and preferably an assembly or technique for strengthening and/or reinforcing an existing monopole tower that remedies, at least in part, some or all of the shortcomings of existing techniques.

### SUMMARY OF THE DISCLOSURE

In a first aspect, at least one embodiment provides a reinforcement assembly for a monopole. The reinforcement assembly comprises three or more columns that are secured in spaced relation away from an outer surface of the monopole. Each of the columns has a cross-section that defines a square or rectangular hollow section and is arranged to extend between a first and second distal end, where the first distal end of each of the columns is secured to a foundation of the monopole, and the second distal end of each of the columns is located at a height that above a height of the first distal end. The columns are arranged such that, in use, a load applied to the monopole is distributed between the monopole and each of the three or more columns. The applied load may be proportionally transferred between the monopole and each of the three or more columns at every height where the columns are provided alongside the monopole.

In some embodiments, between approximately 40% to 70% of the load may be distributed from the monopole to the three or more columns. In some embodiments, the cross-section of each of the columns can comprise a compound of two symmetrical C-sections welded together to define the square or rectangular hollow section.

In some embodiments, the three or more columns may be spaced equidistantly around a circumference of the monopole. In some embodiments, the assembly may provide a substantially symmetrical arrangement of shapes and lines, which may further improve the visual aesthetic of the monopole, in comparison with some existing reinforcement assemblies.

In some embodiments, a horizontal clearance may be provided between each of the columns and the existing cable trays, antennas, and associated mounts, thereby enabling the assembly to be installed on the monopole around the existing cable trays, antennas, and associated mounts. Advantageously, the existing cable trays, antennas, and associated mounts may not need to be removed and the antenna service may not need to be disconnected during the installation. In addition, the horizontal clearance and location of the reinforcement assembly around the monopole may enable the monopole to be inspected and repaired without removing the reinforcement assembly. For example, this may be useful when checking for corrosion on the monopole. In some embodiments, additional antenna headframes, mounts, and cable trays can be attached directly to the outer surface of the monopole without being obstructed by the installed reinforcing assembly.

In some embodiments, each of the columns may comprise a plurality of segments, each of the plurality of segments being coupled together so as to enable continuous transfer of the load between an adjacent two segments of the plurality of segments. The plurality of segments may advantageously assist in reducing the cost of manufacturing and installation, as well as the transport of the assembly to the site of the monopole. For example, the weight of each individual component of the assembly may be below 170 kg. This may advantageously enable the assembly to be installed using a pulley for lifting rather than requiring heavy machinery such as cranes or a cherry-picker.

In some embodiments, a connecting bracket may be fixed to one or more side of each segment of the adjacent two segments proximal an end thereof so as to couple the adjacent two segments together. In some embodiments, the connecting bracket may comprise one or more slotted holes. The slotted holes may improve the case of adjustment of the columns coupled by the connecting brackets. In some embodiments, the segment of the plurality of segments that locates at the second distal end of each of the columns may be configured to be coupled together with a further segment thereabove. For example, the segment may be pre-drilled with apertures for coupling a connecting bracket. The reinforcing assembly may be easily retrofitted to a monopole, or when already installed may be further upgraded for improved strength, as required. Segments of the columns or components of the assembly may be partially replaced piece-by-piece when required. In some embodiments, the columns can be further strengthened by securing additional reinforcement thereto, such as a further hollow section or plate.

In some embodiments, each of the three or more columns may be secured to the outer surface of the monopole at intervals therealong.

In some embodiments, the reinforcement assembly may further comprise a plurality of mounting bracket that are configured to secure each of the three or more columns to the outer surface of the monopole. In some embodiments, the plurality of mounting brackets may each be fixed to the outer surface of the monopole via one or more fastener. In some alternative embodiments, the plurality of mounting brackets may each be collar mounted to the outer surface of the monopole. In some embodiments, each of the plurality of mounting brackets may comprises one or more slotted holes. The slotted holes may be configured in a surface of the mounting bracket that is adapted to locate in use adjacent a side wall of one of columns. The slotted holes may improve the case of adjustment and installation of the columns secured to the monopole by the mounting brackets.

In some embodiments, the three or more columns and/or the mounting brackets and/or the connecting bracket may be formed from steel.

In some embodiments, the first distal end of each of the columns may be secured to the foundation using a cast-in or chemical anchor. In some embodiments, a stub assembly may be arranged at the first distal end of each column. The cast-in or chemical anchor may be configured to fix the stub assembly to the foundation. In some embodiments, a plurality of the stub assemblies may be provided at the first distal end of each column, and spaced around the perimeter of the column.

In some embodiments, a ladder may be arranged on one or more of the columns. In some embodiments, the ladder may be a step bolted access ladder. In some embodiments, the assembly may further comprise an anti-climb system.

In some embodiments, a column of the three or more columns may be split into two or more channels proximal the first end thereof, with each of the two or more channels being secured to the foundation.

In a second aspect, at least one embodiment provides a method of reinforcing a monopole, the method comprising securing three or more columns in spaced relation away from an outer surface of the monopole, each of the columns having a cross-section that defines a square or rectangular hollow section, a first distal end of each of the columns being secured proximal to a foundation of the monopole, and a second distal end of each of the columns being located above the first end; and anchoring the first distal end of each of the three or more columns to the foundation of the monopole.

The columns are arranged such that, in use, a load applied to the monopole is distributed between the monopole and each of the three or more columns. In some embodiments, the columns may be arranged to extend in a direction that is substantially parallel to a longitudinal axis of the monopole. In some embodiments, where the monopole tapers in diameter from the base to the top, the columns may be arranged at a slight incline where the second distal end of the columns is closer to the longitudinal axis of the monopole than the first distal end of the columns.

In some embodiments the method may further comprise, prior to securing three or more columns to the outer surface of the monopole, installing a plurality of mounting brackets to the outer surface of the monopole, whereby the three or more columns are able to be secured, in use, to the outer surface of the monopole via the a plurality of mounting brackets.

In some embodiments, the plurality of mounting brackets may be spaced equidistantly around a circumference of the monopole.

In some embodiments, the method may further comprise vertically aligning an upper row of the plurality of mounting brackets with a lower row of the plurality of mounting brackets.

In some embodiments, each row of the plurality of mounting brackets may be installed at spaced intervals along the outer surface of the monopole. In some embodiments, the spacing of the intervals may be equal between each of the rows of the mounting brackets. In some embodiments, the spacing of the intervals may not be equal between each of the rows of the mounting brackets. In some embodiments, the plurality of mounting brackets may be installed via one or more fastener to the outer surface of the monopole. In some embodiments, the plurality of mounting brackets may be installed via collar mounting to the outer surface of the monopole. In some embodiments, each of the plurality of mounting brackets may comprise one or more slotted holes, the slotted holes being configured in a surface of the mounting bracket that is adapted to locate in use adjacent a side wall of one of columns.

In some embodiments, each of the columns may comprise a plurality of segments, and wherein the method further comprises coupling each of the plurality of segments together so as to enable continuous transfer of the load between an adjacent two segments of the plurality of segments. In some embodiments, a connecting bracket may be fixed to one or more side of each segment of the adjacent two segments proximal an end thereof so as to couple the adjacent two segments together. In some embodiments, the connecting bracket may comprise one or more slotted holes. In some embodiments, the segment of the plurality of segments that locates at the second distal end of each of the columns may be configured to be coupled together with a further segment thereabove.

In some embodiments, the three or more columns may be spaced equidistantly around a circumference of the monopole.

In some embodiments, the three or more columns and/or the mounting brackets and/or the connecting bracket may be formed from steel.

In some embodiments, in the anchoring step the first distal end of each of the columns may be anchored to the foundation using a cast-in or chemical anchor. In some embodiments, a stub assembly may be arranged at the first distal end of each column. The cast-in or chemical anchor may be configured to anchor the stub assembly to the foundation. In some embodiments, a plurality of the stub assemblies may be provided at the first distal end of each column.

In some embodiments, a ladder may be arranged on one or more of the columns. In some embodiments, the assembly may further comprise an anti-climb system.

In some embodiments, a column of the three or more columns may be split into two or more channels proximal the first end thereof, each of the two or more channels being anchored to the foundation.

### DESCRIPTION OF THE FIGURES

Embodiments of the invention are described herein, by way of example only, with reference to the accompanying drawings, in which:

FIG. 1A is a side view of a first embodiment of non-reinforced monopole tower, a single antenna headframe being mounted atop the monopole tower.

FIG. 1B is a plan view from above through section A-A of FIG. 1A.

FIG. 2A is a side view of a second embodiment of non-reinforced monopole tower, with two antenna headframes mounted to the monopole tower.

FIG. 2B is a plan view from above through section B-B of FIG. 2A.

FIG. 3A is a side view of a further embodiment of a monopole tower comprising a first embodiment of the disclosed reinforcement assembly, the monopole tower having three antenna headframes mounted thereto.

FIG. 3B is a plan view from above through section C-C of FIG. 3A.

FIG. 3C is a plan view from above through section D-D of FIG. 3A.

FIG. 4A is a close-up side view of an upper portion of the first embodiment of the reinforcement assembly, when mounted to a monopole tower.

FIG. 4B is a plan view from above through section E-E of FIG. 4A.

FIG. 5A is a close-up side view of a base portion of the first embodiment of the reinforcement assembly, when mounted to a monopole tower.

FIG. 5B is a plan view from above through section F-F of FIG. 5A.

FIG. 6 is a projection view of a base portion of a further embodiment of a monopole tower with a further embodiment of the reinforcement assembly partially installed thereto.

FIG. 7A is a close-up side projection view of an intermediate portion of a further embodiment monopole tower with a further embodiment of the reinforcement assembly partially installed thereto.

FIG. 7B is a close-up side projection view of an intermediate portion of a further embodiment monopole tower with a further embodiment of the reinforcement assembly installed thereto.

FIG. 8 is a projection view of a base portion of a further embodiment of a monopole tower and the reinforcement assembly, where a column is split into two channels proximal the base thereof and each of the two channels are secured to the foundation.

FIG. 9 is a projection view of a base portion of the embodiment of FIG. 8, with an anti-climb system installed thereto.

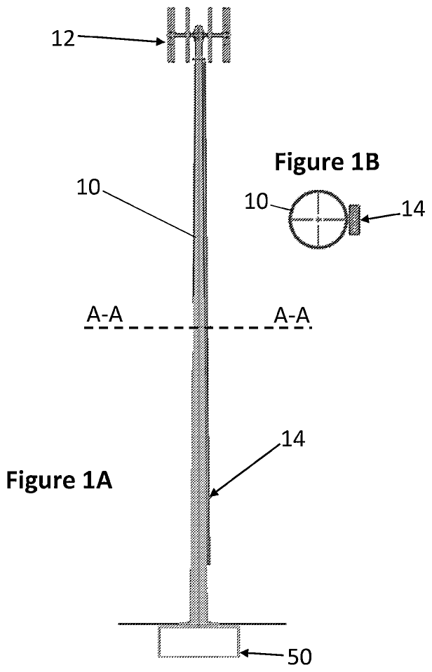

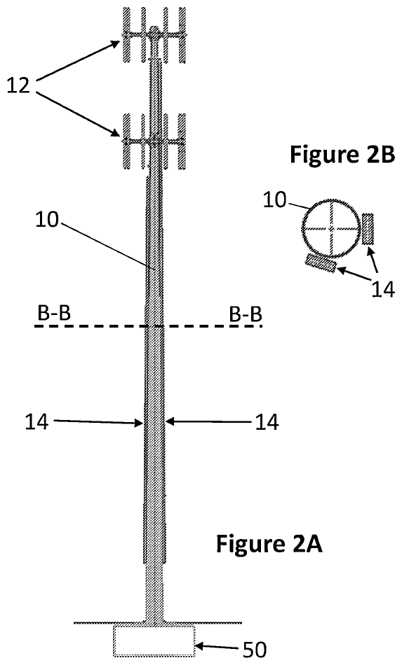

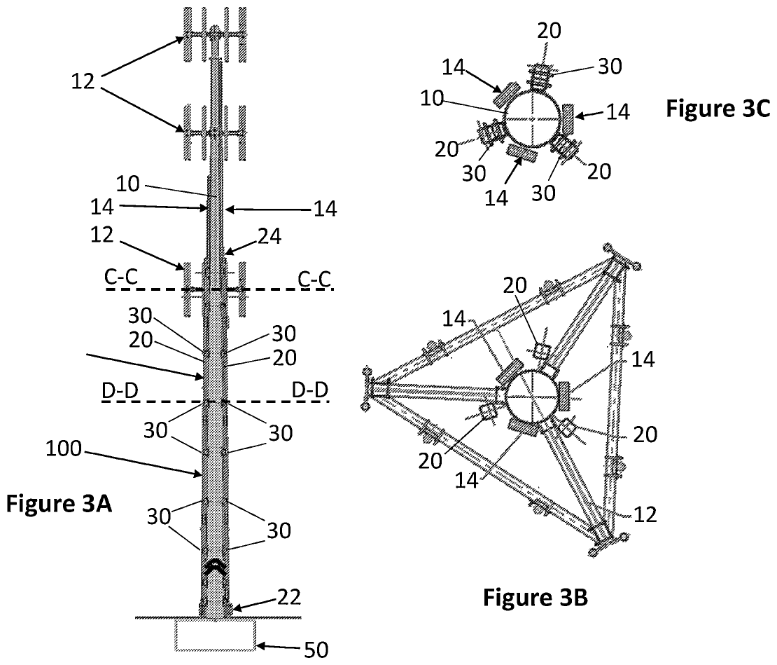

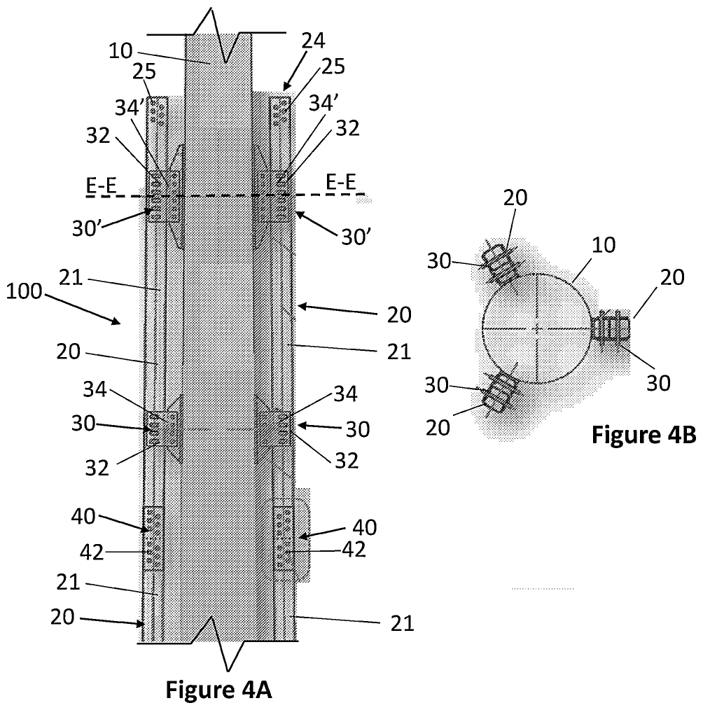

### DETAILED DESCRIPTION

Referring to the Figures, embodiments are shown of a reinforcement assembly 100 that is suitable for installation onto monopole towers 10, and designed to transfer a load applied to the monopole 10 proportionally there between so as to structurally strengthen the load capacity of the monopole tower 10. Where reference is made to a load, this refers to loads that may be applied to the monopole tower such as, but not limited to, lateral or bending moment forces applied by a wind, in addition to the weight force of the electronic equipment, and other equipment fixed to the tower. The reinforcement assembly 100 increases the load capacity of the monopole tower 10 and can enable the reinforced monopole tower 10 to support the weight of additional antenna headframes 12 and cable trays 14, and may advantageously facilitate installation without requiring that the existing services, such as communications services, be disconnected for a period of time (i.e. “service downtime”). The reinforcement assembly 100 may also improve the aesthetics of the monopole tower 10 reinforcement by providing a minimalistic construction that is also cost-efficient.

The reinforcement assembly 100 comprises three or more columns 20 that are secured to the outer surface of the monopole tower 10 by a plurality of mounting brackets 30. The mounting brackets 30 retain the columns 20 in spaced relation away from an outer surface of the monopole tower 10. The clearance provided between the columns 20 and outer surface of the monopole tower 10 may advantageously enable the reinforcement assembly 100 to be installed onto the monopole tower 10 without requiring that the existing services, such as communications services, be disconnected for a period of time (i.e. “service downtime”). The columns 20 can be spaced away from the outer surface of the monopole tower 10 by a distance such that the radius of gyration of the monopole tower 10 is increased by the reinforcement assembly 100, whereby the effective cross-sectional moment of inertia and flexural stiffness of the combined assembly defined by the monopole tower 10 and reinforcement assembly 100 is increased in comparison to a non-reinforced monopole tower 10 of the same dimensions. In some variations, the natural frequency of the combined assembly defined by the monopole tower 10 and reinforcement assembly 100 is increased, effectively increasing the load capacity of the monopole tower 10. In some variations, the acrodynamic shape factor of the existing monopole tower 10 may advantageously remain unmodified by the installation of the reinforcement assembly 100 with the columns 20 in spaced relation away from an outer surface of the monopole tower 10.

Each of the columns 20 are secured in a substantially vertical alignment alongside the monopole tower 10, extending between a lower distal end 22 and an upper distal end 24, with each column 20. The columns 20 are configured to extend upwards longitudinally alongside the monopole tower 10 to an upper distal end 24 located at a height that is above the height of the lower distal end 22. For example, one or both of the lower distal end 22 and upper distal end 24 can locate intermediate a base and a top of the monopole tower 10. In some variations, not shown, the upper distal end can locate at a height that is above the height of the upper distal end of the monopole tower. Where reference is made to upward or vertical alignment, it may be understood that the alignment includes a tilted angle, for example, where the upper cross-sectional diameter of the monopole tower is smaller than the lower cross-sectional diameter of the monopole tower.

The three or more columns 20 are spaced equidistantly around a circumference of the monopole tower 10, or around the perimeter of a non-circular cross-section monopole tower. Where three columns 20 are used, the columns can be spaced at approximately 120 degrees from one another around the outer surface of the monopole tower 10. Where six columns 20 are used, the columns can be spaced at approximately 60 degrees from one another around the outer surface of the monopole tower 10. Where eight columns 20 are used, the columns can be spaced at approximately 45 degrees from one another around the outer surface of the monopole tower 10. As would be understood by one skilled in the art, the number of columns 20 used can vary based on the height and diameter of the monopole tower 10 and/or the structural strength of each column 20. The three or more columns 20 provide a cumulative reinforcement effect for the monopole tower 10, with the spacing of the columns 20 enabling each column 20 to effectively balance against the corresponding opposing compression or tension forces exerted on the other columns 20 of the reinforcement assembly 100. In this manner, the reinforcement assembly 100 is able to efficiently and effectively reinforce the monopole tower 10 at every height where the columns 20 are provided alongside the monopole tower 10, with the columns 20 being arranged such that, in use, a load applied to the monopole tower 10 is distributed and shared proportionally between the monopole tower 10 and each of the columns 20. For example, in some forms the monopole tower 10 and the reinforcement assembly 100 can be configured to bear an approximately 50% share of the total load. In some variations, the reinforcement assembly can be configured to bear between approximately 40% to 70% share of the total load. As would be understood by one skilled in the art, the length, thickness and structural strength of the components of the reinforcement assembly can be modified to bear a smaller or greater percentage of the total load, as required.

In addition to being mounted to the outer surface of the monopole tower 10 via the plurality of mounting brackets 30, the lower distal end 22 of each column 20 is further secured to the concrete foundation 50 surrounding the monopole tower 10 using a cast-in or chemical anchor 54. A plurality of stub assemblies 52 are arranged in a spaced manner around the lower distal end 22 of each column 20, with a cast-in or chemical anchors 54 passing through each stub assembly 52 such that the in-use lower end of the anchor 54 is fastened within the foundation 50. For example, the stub assembly 52 can comprise an upper and lower plate that is welded to a side or front wall of the column 20 with a spacer freely positioned, or welded, so as to locate between the plates. The cast-in or chemical anchor 54 is passed through an aligned aperture of the upper and lower plates and the spacer, and then anchored into the foundation 50, thereby fixedly coupling the column 20 to the foundation 50 whereby a load applied to the column 20 in use can be distributed from the column 20 through the anchors 54 and into the foundation 50. The existing foundation provided in a ground surface adjacent to, and around, the monopole tower 10 can be used as the foundation 50 for anchoring the columns 20 of the reinforcement assembly 100. The reinforcement assembly 100 is able to efficiently transfer and distribute at least a portion of the load applied to the monopole tower 10 into the foundation 50 via the anchoring of each of the columns 20 with the foundation 50. In some variations, the entirety, or at least a majority, of the load transferred into the columns 20 of the reinforcement assembly 100 from the monopole tower 10 can be evenly distributed via the stub assemblies 52 and anchors 54 into the foundation 50, whereby the expected load capacity is constant from the foundation 50 to upper distal end 24 of the columns 20. By transferring at least a portion of the applied load into the foundation 50 beneath the monopole tower 10, the combined load capacity of the monopole tower 10 and reinforcement assembly 100 is increased at every height where the columns 20 are provided alongside the monopole tower 10, from the foundation 50 through to the upper distal end 24.

The columns 20 can be formed to have cross-section that defines a square or rectangular hollow section that extends for the entire longitudinal length of the column 20. A square or rectangular hollow section may advantageously provide improved strength under compression and/or tension loads in comparison with other cross-sectional shapes, such as circular hollow sections or solid rods due to having a superior radius of gyration. In addition, whilst segments of circular hollow sections or rod typically require welded flanges connected with bolts, square or rectangular hollow sections can be connected using independent non-welded connecting brackets 40 and bolts. This may advantageously simplify the manufacturing process and/or the installation of the columns 20.

In some variations, the cross-section of each column 20 can be formed as a compound of two symmetrical C-sections that are welded or otherwise fixed together to define the square or rectangular hollow section. In some variations, the cross-section of each column 20 can be formed as a compound of two square or rectangular hollow sections that are welded or otherwise fixed together to define together a larger combined square or rectangular hollow section of greater strength under compression and/or tension loads. This may advantageously enable the load capacity of the columns 20 to be easily increased. The compound of the two square or rectangular hollow sections can be formed prior to installation, or by retrofitting the additional square or rectangular hollow sections onto the already installed columns 20. As would be understood by one skilled in the art, the thickness and dimensions of the hollow section can be modified as required, for example the wall thickness can be increased to provide increased strength, as required.

The opposing side walls of each column 20 can be pre-drilled with one or more sets of apertures 25 that are spaced along the longitudinal length of the column 20, the apertures being arranged so as to facilitate engagement via one or more fasteners to the mounting brackets 30 or connecting brackets 40, where required. For example, apertures 25 can be pre-drilled proximal to the lower 22 or upper 24 distal ends, respectively, as well as at one or more location along the opposing side walls of the column 20 intermediate the lower 22 and upper 24 distal ends. As would be understood by one skilled in the art, the spacing of the one or more sets of apertures 25 can be staggered evenly along the longitudinal length of the column 20. In some variations, the spacing of the one or more sets of apertures 25 can be at uneven intervals, or follow a pre-defined pattern, or configured to facilitate a tailored arrangement that avoids obstructing pre-existing attachments along the outer surface of the monopole tower 10.

Each of the columns 20 are formed by coupling a plurality of column segments 21 together using a connecting bracket 40 that is fixed to one or more of the opposing side walls of each segment 21, respectively. The plurality of column segments 21 may advantageously assist in reducing the cost of manufacturing and installation, as well as the transport of the assembly to the site of the monopole tower 10. For example, the weight of each individual component of the assembly 100, including the column segments 21, may be below 170 kg. This may advantageously enable the assembly to be installed using a pulley for lifting rather than requiring heavy machinery such as cranes or a cherry-picker. In a variation, and as would be understood by one skilled in the art, each of the columns 20 can formed from a singular segment that extends between the lower 22 and upper 24 distal ends respectively of the column 20.

The connecting bracket 40 is formed as a planar plate that comprises a plurality of fixing apertures 42 along the length thereof, through which a connecting bracket 40 can be fixed via one or more fasteners to each of the two adjacent segments 21. A corresponding set of apertures 25 is provided on opposing side walls of each segment 21 of the columns 20 proximal the lower and upper distal ends of each segment 21, the arrangement of the fixing apertures 42 being arranged to align with the apertures 25 at the upper distal end of an adjacent lower segment 21 and the apertures 25 at the lower distal end of an adjacent upper segment 21. In use, when coupled together by a connecting bracket 40, the columns are able to transfer at least a portion of the load between two adjacent segments 21, and thereby continuously distribute the load throughout the columns 20 and foundation 50.

In a variation, the apertures 42 of the connecting bracket 40 can be formed as slotted apertures. The slotted apertures may improve the case of adjustment of the columns 20 coupled by the connecting brackets 40.

A mounting bracket 30 can be secured to the column 20 proximal to, and spaced inwardly from, each of the lower 22 and upper 24 distal ends of each column 20. The inward spacing of the mounting brackets 30 from the distal ends 22, 24 along the longitudinal axis of the column 20 leaves the distal ends 22, 24 themselves exposed, whereby the lower distal end 22 can be anchored to the foundation 50 and the apertures 25 at the upper distal end 24 are accessible, if and when required, for coupling of a further column segment 21. Further mounting brackets 30 can be secured to the column 20 intermediate the lower 22 and upper 24 distal ends of each column 20, with each of the mounting brackets 30 also secured to the outer surface of the monopole tower 10 at spaced intervals.

The mounting brackets 30 can be mounted to the outer surface of the monopole via one or more fastener that is drilled through one or more apertures provided through the monopole facing mounting surface of the mounting bracket 30. The mounting surface can be planar, or in some variations can be formed to have a curvature that corresponds to the curvature of monopole tower 10. A plurality of side plates 34 project away from the mounting surface, with a portion of each of the side plates 34 arranged to locate adjacent, so as to align alongside, the opposing side walls of a column 20 that is retained between the plurality of side plates 34 by the mounting bracket 30. A plurality of slotted holes 32 are provided through the portion of each of the side plates 34 that locates adjacent the side walls of the column 20, with the slotted holes 32 extending laterally across the surface of side plates 34. A pair of aligned slotted holes 32, one defined in each of the opposing side plates 34 of a mounting bracket 30, enable a fastener to be passed through the mounting bracket 30 and column 20 so as to secure the column 20 to the mounting bracket 30. For example, where a bolt and nut arrangement is used, the head of the bolt can locate against a first outer facing side of a first of the side plates 32, and the nut can be tightened against a second outer facing side of a second of the side plates 32 of the mounting bracket 30, with the bolt passing through the pair of slotted holes 32 and the column 20 that is retained between the side plates 32 of the mounting bracket 30. The slotted holes 32 facilitate increased flexibility when vertically aligning the column 20 within the mounting brackets 30 as well as improving the case of adjustment of the columns 20 when required. In use, when the plurality of fasteners have been tightened to secure the column 20 to the mounting bracket 30, a moment connection is defined thereat. In some variations, the mounting brackets 30′ proximal to the respective upper distal ends 24 of each column 20 can be larger than the other mounting brackets 30 of the reinforcement assembly 100, and have additional slotted holes 32 therethrough to facilitate a stronger connection point.

The mounting brackets 30 can be mounted directly onto the outer surface of the monopole tower 10 whereby the reinforcement assembly 100 has the flexibility to be installed onto monopole towers 10 having a wide variety of diameters. In a variation, not shown, where the drilling of fasteners into the monopole tower is not possible or undesirable, the mounting brackets can be collar mounted to the outer surface of the monopole.

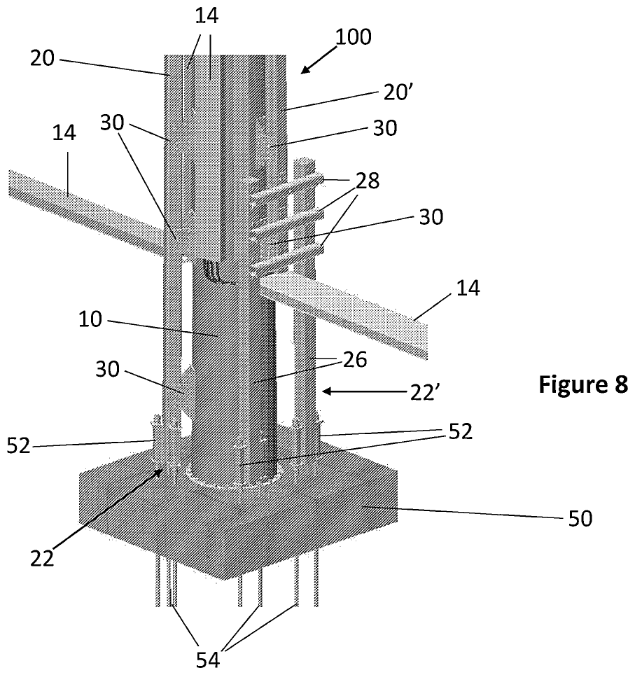

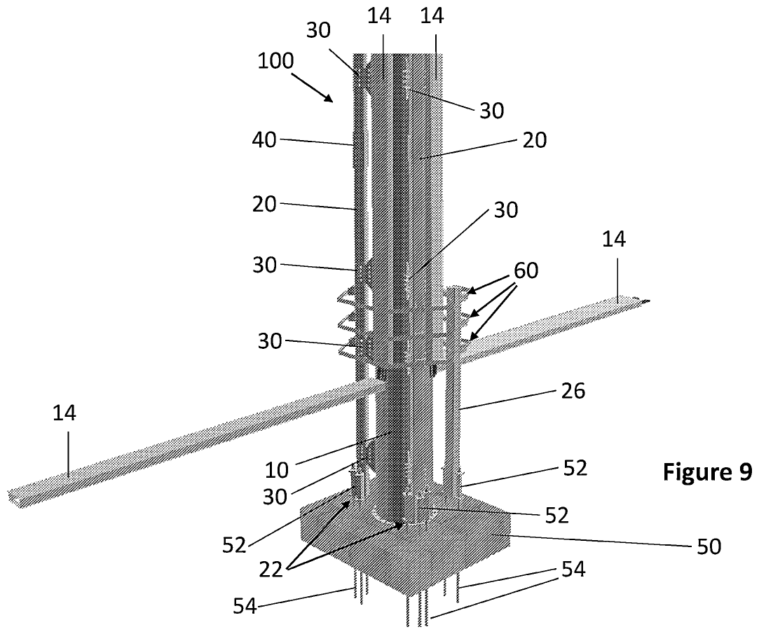

In a variation, referring to FIGS. 8 and 9, where the location of a cable tray 14 or other attachments on the outer surface of the monopole tower 10 obstruct the lower distal end 22′ of a column 20′ from extending linearly downwards at the desired equidistant spacing around a circumference of the monopole tower 10, the lower portion of the column 20′ can be split into two or more channels 26 that diverge around the cable tray 14 or other attachment and extend downwardly from the lower distal end 22′ of a column 20′ so as to be secured to the foundation 50. The channels 26 can be formed to have the same, or similar, cross-sectional shape and diameter as the columns 20. A plurality of beams 28 couple the lower distal end 22′ of a column 20′ to the upper portion of each of the channels 26, with each of the channels 26 being arranged to locate parallel to, and on opposing sides of, the column 20′ at a spaced distance so as not to obstruct access to the cable tray 14 or other attachment. The plurality of beams 28 facilitate a force transfer between the column 20′ and the channels 26, whereby they act as a substantially continuous reinforcement member.

A horizontal clearance is provided between the spacing of the mounting brackets 30 and columns 20 around the circumference of the monopole tower 10, providing access to the existing cable trays 14, antennas 12, and associated mounts. This enables the reinforcement assembly 100 to be installed onto the monopole tower 10 around the existing cable trays 14, antennas 12, and associated mounts. Thus, the antenna service may not need to be disconnected. In addition, the spacing and location of the assembly 100 around the monopole tower 10 enables the monopole to be fully inspected and repaired, when required, for example to check for corrosion on the monopole. Additional antenna headframes, mounts, and cable trays can be attached directly to the outer surface of the monopole without access being obstructed by the reinforcing assembly.

The reinforcement assembly 100 can be easily retrofitted onto an existing monopole tower 10, as required. In addition, the reinforcement assembly 100 can be further upgraded or strengthened by adding further segments 21 of the columns 20, or by replacing and/or by securing additional reinforcement directly onto the columns 20. For example, the columns 20 can be reinforced by mounting a further hollow section or plate directly onto a front or side wall of each of the columns 20. Having a column 20 formed from multiple conjoined segments 21 assists with quick and easy maintenance of the columns 20 when required, allowing for damaged or weakened segments to be removed and replaced piece-by-piece when required.

As would be understood by one skilled in the art, the components of the reinforcement assembly can be manufactured from stainless steel or other similar metals such as hot rolled or cold formed steel, high strength or medium strength steel and may have a galvanised or painted finishing. In some variations, polymer based materials such as fibre reinforced plastic or high density polymers may also be suitable for use when manufacturing part or all of the components of the assembly.

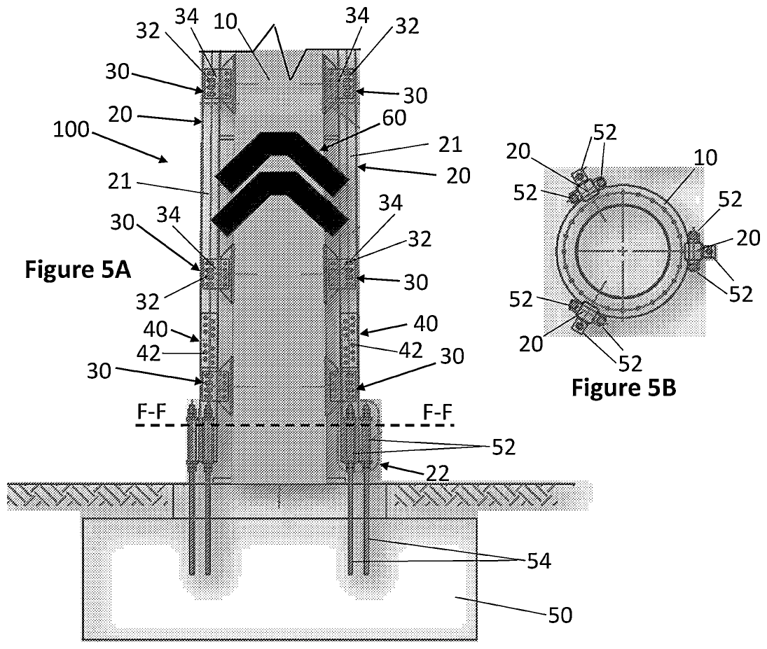

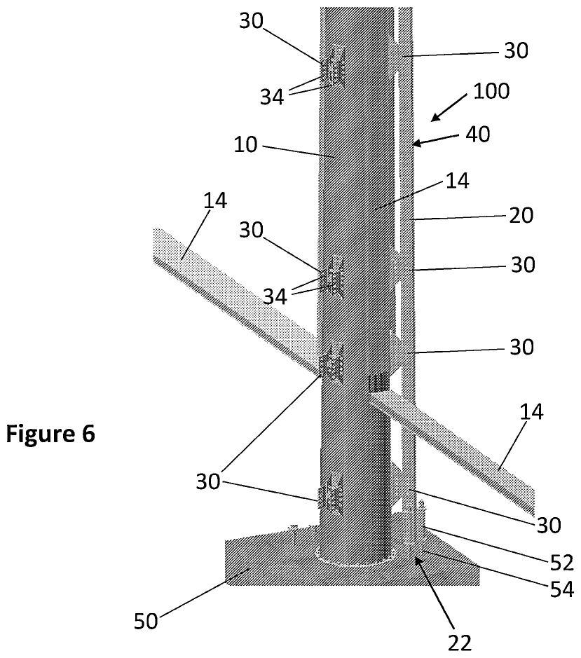

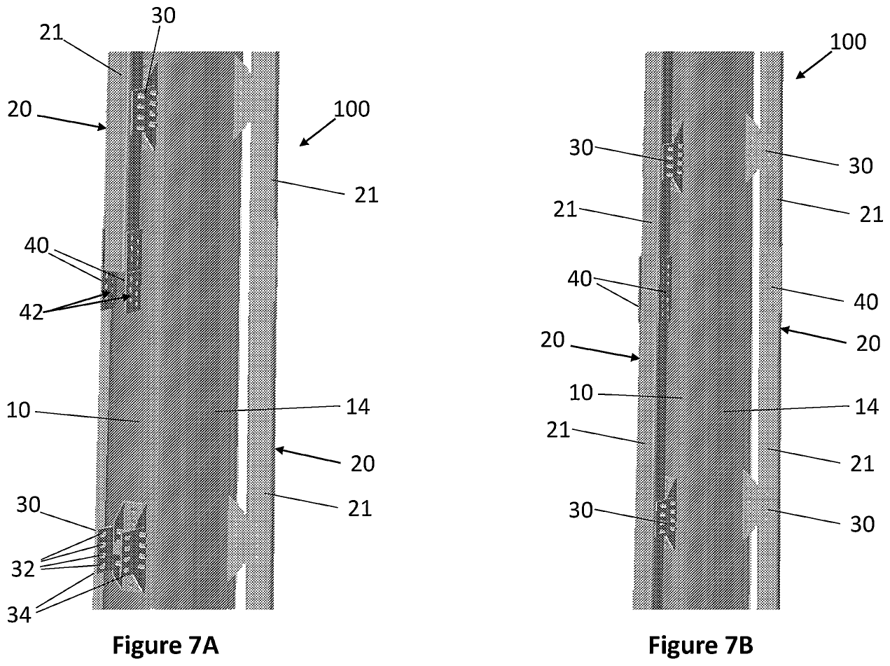

In a variation, not shown, a step bolted access ladder or similar climbing aid can be provided up one or more of the columns of the reinforcement assembly. In some variations, an anti-climb system or barrier 60 can be provided around the reinforcement assembly (for example, see FIGS. 5 and 9). In some variations, the anti-climb system or barrier 60 can comprise, at least in part, the shape of a company logo. For example, with reference to FIG. 5A, the anti-climb system or barrier 60 can comprise a pair of upwardly pointing arrow-heads. In some variations, with reference to FIG. 9, the anti-climb system or barrier 60 can comprise a plurality of parallel bars that encircle the monopole tower 10 and are spaced from one another.

When installing the reinforcement assembly 100, the mounting brackets 30 are secured to the outer surface of the monopole tower 10, starting from the bottom of the monopole tower 10 and spacing the mounting brackets 30 equidistantly at approximately 120 degrees from one another (i.e. for three columns). Each additional row of mounting brackets 30 is aligned horizontally with one another, and vertically with the already mounted lower row of mounting brackets 30, then drilled or otherwise secured into place on the outer surface of the monopole tower 10.

Segments 21 of the columns 20 are then fastened to the mounting brackets 30. The segments 21 can all have a singular fixed length, or be formed to have a plurality of different lengths. For example, in some forms the segments can all be spliced into 5 metre long sections that have a weight less than 170 kg.

The lowermost segment 21 is secured first to the lowermost mounting brackets 30, and then secured progressively upwards to the higher mounting brackets 30. Each additional segment 21, when added above and adjacent to the segment 21 that locates immediately therebelow, is secured to the lower segment 21 by a pair of connecting brackets 40 that locate on either side of each of the adjacent segments 21 proximal to the ends being joined. The upper distal end 24 of each of the columns 20 may preferably extend between 50% and 66.6% of the total height of the monopole tower 10, however in some variations, the upper distal end 24 of each of the columns 20 can be as high as the monopole tower 10 itself. In some further variations, the upper distal end 24 of each of the columns 20 can be as low as 33% of the total height of the monopole tower 10.

The resulting column 20 formed by the cumulative coupling of the adjacent segments 21 thus arranged to extend in a direction that is substantially parallel to a longitudinal axis of the monopole tower 10, although in some forms, where the monopole tower 10 tapers in diameter from the base to the top of the monopole tower 10, the columns 20 may be arranged at a slight incline where the upper distal end 24 of the columns 20 is closer to the longitudinal axis of the monopole tower 10 than the lower distal end 22 of the columns 20. The connection between the columns 20 and the monopole tower 10, via the mounting brackets 30, enables a load that is applied to the monopole to be proportionally distributed between the monopole tower 10 and each of the three or more columns 20.

Lastly, the portion of the lowermost segments 21 of the columns 20, proximal the lower distal end 22 of the columns 20, is anchored to the foundation 50 using cast-in or chemical anchors. The anchoring of the columns 20 to the foundation 50 facilitate the continued load distribution from the columns 20 into the foundation 50 of the monopole tower 10.

Variations and modifications will be apparent to those skilled in the art without departing from the spirit or scope of the present invention.

1.-44. (canceled)

45. A reinforcement assembly for a monopole, the reinforcement assembly comprising three or more columns secured in spaced relation away from an outer surface of the monopole, each of the columns having a cross-section that defines a square or rectangular hollow section and being arranged to extend between a first and second distal end, the first distal end of each of the columns being secured to a foundation of the monopole, and the second distal end of each of the columns being located at a height that is above a height of the first distal end, the columns being arranged such that, in use, a load applied to the monopole is distributed between the monopole and each of the three or more columns.

46. The reinforcement assembly of claim 45, wherein, between approximately 40% to 70% of the load is distributed from the monopole to the three or more columns.

47. The reinforcement assembly of claim 45, wherein each of the columns comprises a plurality of segments, each of the plurality of segments being coupled together so as to enable continuous transfer of the load between an adjacent two segments of the plurality of segments.

48. The reinforcement assembly of claim 47, wherein a connecting bracket is fixed to one or more side of each segment of the adjacent two segments proximal an end thereof so as to couple the adjacent two segments together.

49. The reinforcement assembly of claim 45, wherein each of the three or more columns are secured to the outer surface of the monopole at intervals therealong.

50. The reinforcement assembly of claim 45, wherein the reinforcement assembly further comprises a plurality of mounting bracket that are configured to secure each of the three or more columns to the outer surface of the monopole.

51. The reinforcement assembly of claim 50, wherein the plurality of mounting brackets are each fixed to the outer surface of the monopole via one or more fastener or are each collar mounted to the outer surface of the monopole.

52. The reinforcement assembly of claim 45, wherein the first distal end of each of the columns is secured to the foundation using a cast-in or chemical anchor.

53. The reinforcement assembly of claim 52, wherein a stub assembly is arranged at the first distal end of each column, the cast-in or chemical anchor being configured to fix the stub assembly to the foundation.

54. The reinforcement assembly of claim 45, wherein a column of the three or more columns is split into two or more channels proximal the first end thereof, each of the two or more channels being secured to the foundation.

55. A method of reinforcing a monopole, the method comprising
securing three or more columns in spaced relation away from an outer surface of the monopole, each of the columns having a cross-section that defines a square or rectangular hollow section, a first distal end of each of the columns being secured proximal to a foundation of the monopole, and a second distal end of each of the columns being located above the first end; and
anchoring the first distal end of each of the three or more columns to the foundation of the monopole.

56. The method of claim 55, wherein the method further comprises, prior to securing three or more columns to the outer surface of the monopole, installing a plurality of mounting brackets to the outer surface of the monopole, whereby the three or more columns are able to be secured, in use, to the outer surface of the monopole via the plurality of mounting brackets.

57. The method of claim 56, wherein the method further comprises vertically aligning an upper row of the plurality of mounting brackets with a lower row of the plurality of mounting brackets.

58. The method of claim 57, wherein each row of the plurality of mounting brackets is installed at spaced intervals along the outer surface of the monopole.

59. The method of claim 55, wherein the plurality of mounting brackets are installed via one or more fastener or via collar mounting to the outer surface of the monopole.

60. The method of claim 55, wherein each of the columns comprises a plurality of segments, and wherein the method further comprises coupling each of the plurality of segments together so as to enable continuous transfer of the load between an adjacent two segments of the plurality of segments.

61. The method of claim 55, wherein, between approximately 40% to 70% of a load applied to the monopole is distributed from the monopole to the three or more columns.

62. The method of claim 55, wherein in the anchoring step the first distal end of each of the columns is anchored to the foundation using a cast-in or chemical anchor.

63. The method of claim 62, wherein a stub assembly is arranged at the first distal end of each column, the cast-in or chemical anchor being configured to anchor the stub assembly to the foundation.

64. The method of claim 55, wherein a column of the three or more columns is split into two or more channels proximal the first end thereof, each of the two or more channels being anchored to the foundation.
